(19) United States
(12) Patent Application Publication
(10) Pub. No.: US 2008/0315018 A1
(43) Pub. Date: Dec. 25, 2008

(54) Spray Dispenser

(75) Inventor: Philip Craig Withers, Victoria (AU)

Correspondence Address: DORITY & MANNING, P.A., POST OFFICE BOX 1449, GREENVILLE, SC, 29602-1449, US

(73) Assignee: INTELLECTUAL PROPERTY DEVELOPMENT CORPORATION PTY LTD, MELBOURNE, VICTORIA (AU)

(21) Appl. No.: 11/997,768

(22) PCT Filed: Jul. 19, 2006
(86) PCT No.: PCT/AU2006/001006

§ 371 Date: Aug. 22, 2008

(30) Foreign Application Priority Data
Aug. 4, 2005 (AU) 2005904197

(51) Int. Cl. B05B 7/02; B65D 1/02; B05B 7/00

(52) U.S. Cl. 239/526; 215/40; 239/337

(57) ABSTRACT

A trigger spray dispenser (8, 40) that comprises a container (14, 42) for a liquid, the container comprising a reservoir (16, 46) with a base (18), a forward face (30, 48), and a rear face (32, 50), and a neck (15, 52) extending upwardly from the reservoir (16, 46), and a spray discharge head (10, 44) for dispensing the liquid in a generally forward direction (D-D, 58). The neck (15, 52) and head (10, 44) are attached or attachable, the head (10, 44) is in fluid connection with the liquid in the container (14, 42) when attached to the neck (15, 52), at least a portion of the neck (15, 52) is inclined to impart an inclination to the head (10, 44).

### RELATED APPLICATION

This application is based on and claims the benefit of the filing date of Australian application no. 2005904197 filed 4 Aug. 2005, the content of which is incorporated herein by reference in its entirety,

### FIELD OF THE INVENTION

The present invention relates to a spray dispenser, and in particular a trigger spray dispenser having a configuration which is adapted to more easily dispense a cleaning and/or sanitising liquid onto various angled surfaces. The trigger spray dispenser is preferably multidirectional so that it can be used to apply the liquid to a surface in any orientation.

While the following description makes particular reference to the trigger spray dispenser in the context of a preferred application of cleaning and sanitizing a toilet bowl, it will be understood that the trigger spray dispenser can have a wider application in other cleaning and/or sanitation areas.

### BACKGROUND OF THE INVENTION

A large variety of cleaning fluid dispensers are available on the market specifically designed to clean toilet bowls. The main purpose of such dispensers is to apply an active ingredients) such as an antibacterial, antimicrobial and/or cleaning agent under the rim and onto the inner surface of the toilet bowl to clean and/or sanitise the bowl.

Typically, these dispensers comprise a hand squeezable container that squirts or sprays a viscous liquid from an upwardly directed nozzle onto the targeted surfaces of the toilet bowl. The nozzle is designed to squirt or spray (or spray as a foam) the liquid onto the targeted surface, in a thin stream, as a wide spray pattern or as a foam according to application. The liquid is intentionally made viscous through the use of solids to enable the dispensed liquid to cling and thereafter slowly spread and slowly slide down over the surface.

However, the configuration of these type of toilet bowl cleaners is restrictive. The hand squeezable container can only be practically used in an inverted orientation, and the nature of the viscous liquid is only suitable for use within the bowl of the toilet. Furthermore, due to the viscous nature of the liquid, a significant amount of thin liquid must be applied to obtain a substantially complete and even coverage over the inner surface of the bowl.

Furthermore, there also exist foam dispensers of the aerosol type. These are configured for inverted use, and though primarily designed for inside toilet bowls, they are difficult to direct under the rim and moreover cannot be used upright as the active ingredient is not expelled in such an orientation.

### SUMMARY OF THE INVENTION

According to one aspect of the present invention there is provided a trigger spray dispenser comprising;
a container for a liquid, said container comprising a reservoir with a base, a forward face and a rear face, and a neck extending upwardly from said reservoir; and
a spray discharge head for dispensing said liquid;
wherein said neck and head are attached or attachable, said head is in fluid connection with the liquid in the container when attached to said neck, at least a portion of said neck is rearwardly inclined to impart a rearward inclination to said head, and said head has a generally forward and upward axis of discharge.

According to another aspect of the present invention there is provided a liquid container for use as a part of a trigger spray dispenser, said container comprising:
a reservoir with a baser a forward face and a rear face; and
a neck extending upwardly from said reservoir;
wherein said neck is attachable to a spray discharge head for dispensing a liquid from said reservoir, said head being in fluid connection with said liquid when attached to said neck, at least a portion of said neck is rearwardly inclined to impart a rearward inclination to said head when so attached.

The combination of the features of the dispenser of the present invention result in a surprisingly advantageous cleaning fluid dispenser in comparison to background art viscous cleaning liquid dispensers, particularly when used for cleaning and/or sanitising toilet bowls. In this respect:
The configuration of the neck of the container is adapted to more easily dispense the liquid onto an angled target surface;
The shape of the container also provides a better ergonomic shape than previously available trigger spray bottles—this means the end user can more easily and comfortably reach and direct the spray towards difficult to reach areas, such as for example under the rim in a toilet and around the inside and outside curved surfaces of the toilet bowl; and
The use of a spray discharge head (which may also be referred to as a spray discharge body) as opposed to a manual hand squeezable bottle allows a user to more accurately and easily control the amount of fluid dispensed out of the container. The spray discharge head also pressurises the liquid, resulting the liquid being expelled out of the spray discharge head at pressure.

In one particular embodiment, substantially the entire neck is rearwardly inclined.

In another embodiment, the neck comprises an attachment for attaching said head, and said attachment is rearwardly inclined. This attachment may be, for example, a thread corresponding to a threaded portion of the head (and in some cases the thread may be provided on essentially the entire neck).

In certain embodiments, the rearward inclination of the head equals the angle between the axis of discharge and horizontal. That is, in these embodiments the head does not add any further inclination to the axis of discharge—this is entirely governed by the rearward inclination imparted by the neck.

It is preferred that the spray discharge body can function in a plurality of directions. Such a multidirectional spray discharge body gives the dispenser directional versatility allowing a user to dispense the liquid onto a surface orientated at virtually any angle with the dispenser in an upright and/or inverted orientation.

Typically, the liquid dispensed from the spray dispenser can be dispensed in the form of a spray, foam, mist, stream, droplets or the like. The spray discharge head therefore preferably further comprises a nozzle adapted for producing or otherwise forming the particular form of the liquid from the liquid stored in the container.

Typically, the liquid has a clinging ability. This can be achieved using a combination of specific polymers and foam action triggers. However, in such embodiments, it is preferable that a thicker foam is created to give a greater cling property.

The liquid formulation also typically contains at least one active ingredient having a cleaning and/or sanitising property. The active ingredient may be at least one of an antibacterial agent, a cleaning agent, a sanitising agent, an antimicrobial agent, a disinfectant, a detergent, a germicide, a fragrance or an insecticide, or combinations thereof.

The angle of the axis of discharge of the liquid dispensed out of the spray discharge body is adapted to allow a user to more easily apply the liquid using the dispenser when using the dispenser in an inverted position. In certain embodiment, therefore, the axis of discharge is at an angle of between 5° to 70° above the horizontal, that is, above the transverse axis of the container.

Nevertheless, the desired axis of discharge is typically determined by the specific application in which the container is to be designed to be used. It has been found for domestic uses, such as cleaning toilets, sinks and other confined spaces that it is preferable for the axis of discharge to be at an upward angle of between 10° to 20° relative to the transverse axis of the container. Hence, in a particular embodiment, the rearward inclination of the head is between 10° and 20°. In another particular embodiment, the rearward inclination of said head is approximately 16.5°, and in yet another embodiment, the rearward inclination of the head is approximately 15°.

The container may comprise one or more compartments. For example in one embodiment of the invention, the reservoir comprises a single chamber. However in another embodiment, the reservoir comprises two separate chambers.

In certain embodiments, the neck is tubular and has a smaller longitudinal cross-sectional diameter than that of the reservoir. In that embodiment it is preferable for the neck to have a configuration which is adapted to position the nozzle in the desired direction. In this respect, substantially the entire neck may be angled or otherwise bent away from an upwards or long axis of the container, being an axis perpendicular to the transverse axis of the container and running upwardly through the length of the container. Externally, this may result in the neck having a bent or somewhat arcuate shape.

Such a bent shape provides several benefits. Firstly, a bent shape is ergonomically designed to allow a user to more easily grip, manipulate, rotate and twist the container and direct the spray from the nozzle towards varying angles in a multidirectional environment without discomfort. Secondly, the progressive curve or bend provided by this shape is aesthetically pleasing, of which is an important consideration to the design of consumer products.

In some embodiments, the neck has a hand grip region to allow a user to hold the container in his or her hand. The hand grip region is therefore adapted to allow a user to grasp or otherwise hold the container in the neck when in use. The hand grip region is typically positioned in close proximity to the lever/trigger of the discharge head. This allows the user to hold the container with a number of fingers on one hand, and also manipulate the lever/trigger of the discharge body with the remaining fingers of the same hand. More importantly, the use of a hand grip on the neck of the container facilitates one handed use of the product, allowing the user to have a free hand to use for other tasks. Typically, the hand grip region comprises a recessed regions finger recesses, an embossed region, an insert such as a elastic polymer insert in the neck, or the like.

The reservoir constitutes the other section of the container. The reservoir comprises a liquid tight body of a shape capable of storing a predetermined amount of liquid. For example, the quantity is commonly between 100 mL and 1.5 L, which provides a small enough weight for a user to continuously lift the Container for the period of use.

While many shapes are possible for the reservoir, such as cylindrical, cubic, rectilinear, spherical, in many embodiments the reservoir has a longitudinal cross-section in which a first or width dimension is greater than a second dimension or forward-to-rear dimension. In one particular embodiment, the reservoir is greater in width across its forward or rear face than in maximum distance between the forward and rear faces. The longitudinal cross-section is commonly generally oblong in shape. The container therefore has in such embodiments two clearly different orientations, the first being a thin dimension corresponding to the forward-face to rear-face distance of the reservoir, and the second being a larger wide orientation corresponding to the width of the reservoir.

As can be imagined, in these embodiments the relative size of these dimensions can effect how a user is able to orientate the container within a confined space, particularly when combined with an angled neck. Accordingly, it in preferable that larger dimension forming the width of the reservoir is orientated generally perpendicular to the transverse axis of the container, and more preferably the horizontal component of the discharge axis.

In one embodiment of the invention, the reservoir comprises a generally rectangular shape having substantially parallel forward and rear faces and substantially parallel side walls. The forward and rear faces may form substantially flat surfaces along planes orientated generally perpendicular to the transverse axis of the container. This provides large surfaces for labels, to provide better brand communication to a purchaser at the point of purchase. In this respect, the larger the dimensions of the transverse axis of the container, the better brand communication at the point of purchase.

In another particular embodiment, the cross-section of the base of the reservoir is substantially oblong and the cross-section of the neck is substantially round, being approximately circular or generally oval, forming a tubular neck.

The container and the spray discharge head can be attached by any suitable known means. The attachment can be permanent, removable, rotatable, pivotable, threaded, friction fitted, snap fitted, by tongue and groove connections, glued or the like. The container and spray discharge head may be connected by a removable means, allowing the spray body to be removed by the user to facilitate refilling of the container.

It should be understood that the container and head may be essentially permanently connected. Indeed, in one embodiment, a connection is provided in the neck so that the head and an upper portion of the neck may be separated from the lower portion of the neck.

It is also to be understood that the terms trigger spray bottle and trigger spray head encompasses any type of manually actuated spray dispenser, whether the spray is pressurized through an internal pump in the spray bottle or by a pump that manually pre-pressurizes the container ready for release of the liquid through the spray head.

### BRIEF DESCRIPTION OF THE DRAWINGS

In order that the invention may be more clearly ascertained, preferred embodiments will now be described, by way of example, with reference to the accompanying drawing, in which:

FIG. 1 is a side elevation of a trigger spray discharge dispenser according to a first embodiment of the present invention, illustrating the orientation of the discharge body relative to the axes of the container body;

FIG. 2 is a front elevation of the trigger spray discharge dispenser of FIG. 1, illustrating the configuration of the liquid reservoir of the container in relation to the orientation of the discharge body;

FIG. 3 is a rear elevation of the trigger spray discharge dispenser of FIG. 1, further illustrating the configuration of the liquid reservoir of the container in relation to the orientation of the discharge body;

FIG. 4 is an enlarged view of the upper portion of the trigger spray discharge dispenser of FIG. 1, showing an enlarged view of the discharge body of the dispenser;

FIG. 5 is a side elevation of a trigger spray discharge dispenser according to a second embodiment of the present invention;

FIG. 6 is a side elevation of a trigger spray discharge dispenser according to a third embodiment of the present invention;

FIG. 7 is a side elevation of a trigger spray discharge dispenser according to a fourth embodiment of the present invention;

FIG. 8 is a front elevation of the trigger spray discharge dispenser of FIG. 7;

FIG. 9 is a rear elevation of the trigger spray discharge dispenser of FIG. 7;

FIG. 10 is an enlarged view of the upper portion of the trigger spray discharge dispenser of FIG. 7, showing an enlarged view of the discharge body;

FIG. 11 is a side elevation of a trigger spray discharge dispenser according to a fifth embodiment of the present invention;

FIG. 12 is a side elevation of a trigger spray discharge dispenser according to a sixth embodiment of the present invention;

FIG. 13 is a partially exploded side view of a liquid container according to a seventh embodiment of the present invention, for use as a part of a trigger spray dispenser;

FIG. 14 is a partially exploded front view of the liquid container of FIG. 13; and

FIG. 15 is a partially exploded rear view of the liquid container of FIG. 13.

### DETAILED DESCRIPTION

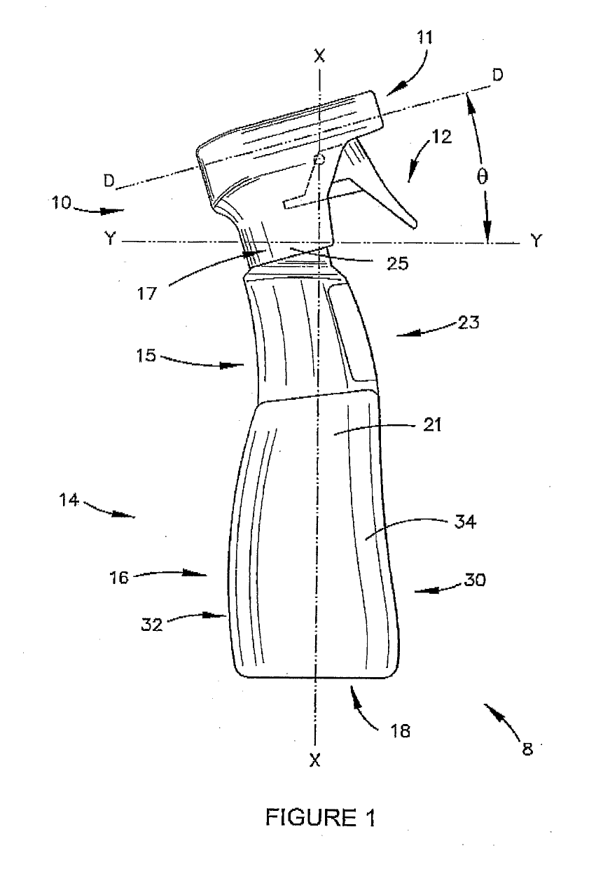

FIG. 1 is a side view of a trigger spray dispenser 8 according to a first embodiment of the present invention. The spray discharge dispenser 8 comprises two interconnected and interrelated sections. The first (or lower) section comprises a container 14, having two distinct and integrally connected portions—a liquid reservoir 16 and a neck 15. The reservoir 16 is an oblong shaped body in which liquid containing an antibacterial and cleaning agents is stored for use in the dispenser. The tubular neck 15 is situated on top of the reservoir 16 and is of an ergonomic design and shape that allows a user to more easily and comfortably reach and direct the spray towards varying angles in a narrow environment (as discussed below).

The second (or upper) section is an invertible spray discharge head in the form of discharge body 10 used to spray the liquid from the liquid reservoir 16 and out of a nozzle 11 as a foam onto the targeted surface. The spray discharge container is attached on top of the neck 15 of the container over the opening 17 and is in fluid communication with the liquid stored in the container through a dip tube (not illustrated).

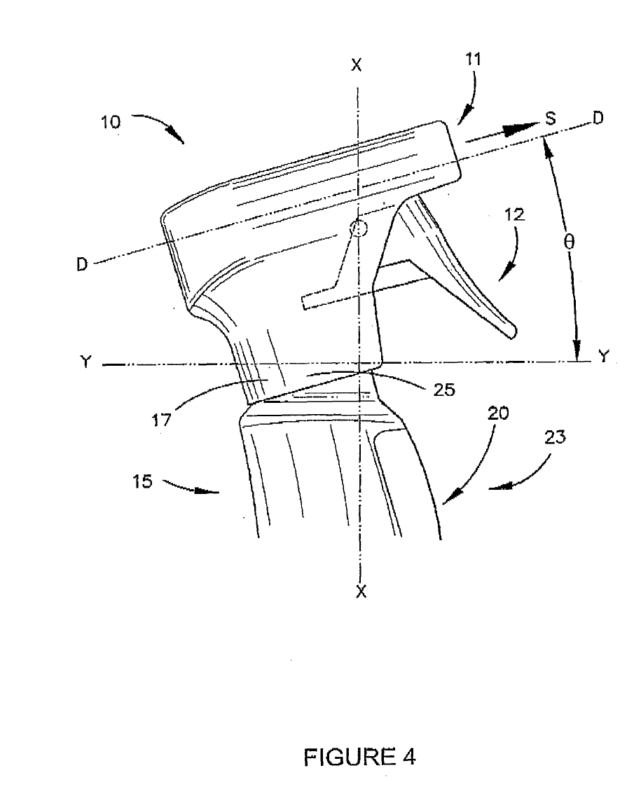

As can be observed from FIGS. 1 and 4, the shape and configuration of the neck 15 of the container 14 has been adapted to orientate the nozzle 11 of the discharge body 10 in a positive angle θ (or in an upwardly direction as illustrated in the figures) relative to the transverse axis of the container Y-Y. In turn, the discharge body 10 must be adapted to function normally in this angled position. In this way each of the discharge body 10 and container 14 provide features which in combination result in the advantages provided by the present trigger spray dispenser 8.

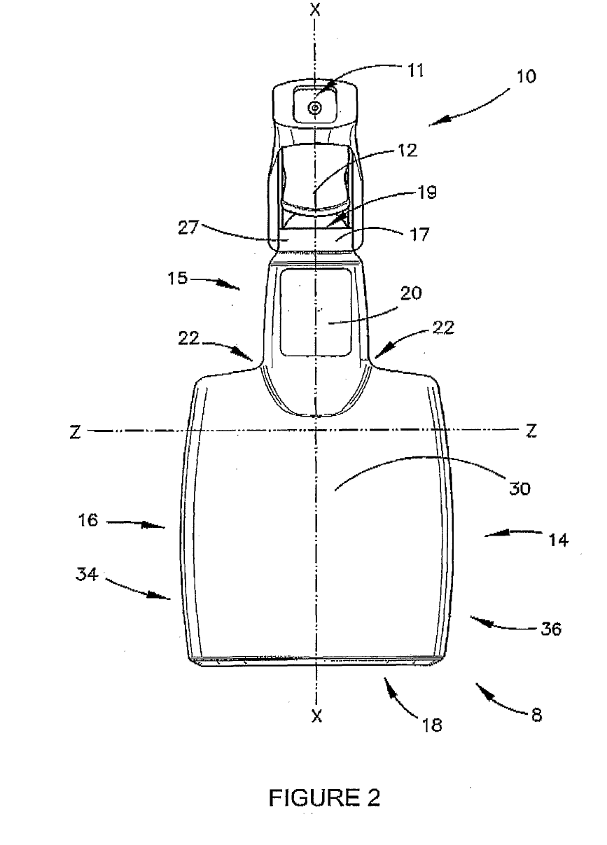

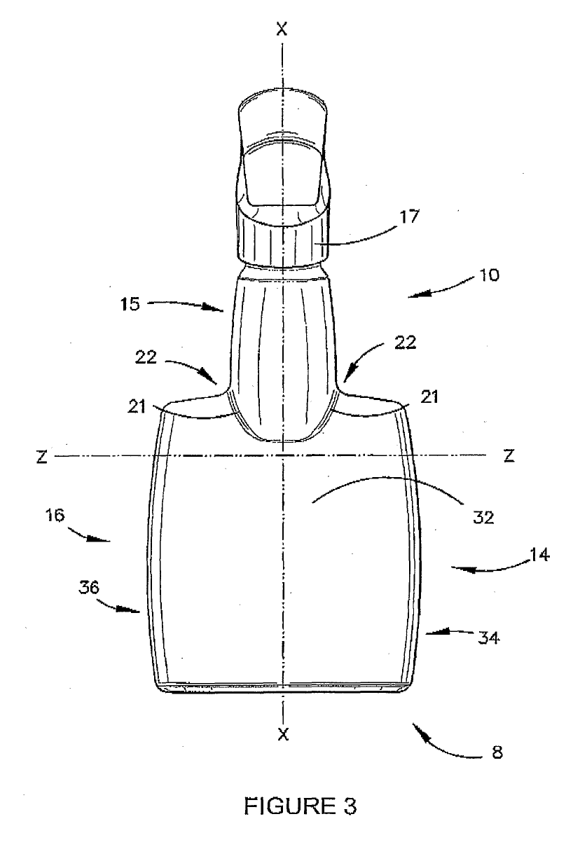

The neck 15 of the container 14 has an angular or bent tubular configuration. As shown in FIG. 1, the neck 15 is progressively curved relative to the upwards or long axis X-X of the container in a plane parallel to axis X-X and axis Y-Y of the container 14. Effectively, the neck 15 of the container 14 is angled or bent backwardly away from the upwards axis X-X of the container 14, towards the rear side 32 of the reservoir 16 of the container 14. In comparison, as shown in FIGS. 2 and 3, when looking at the container in a plane parallel to the lateral axis z-z and upwards axis X-X of the container 14, the shape of the projection of the front and rear faces of the tubular neck 15 is upright and symmetrical about the upwards axis X-X. The shape of the curve or bend of the neck 15 has been selected to orientate the axis of discharge D-D of the nozzle 11 in a positive angle away from the transverse axis Y-Y of the container 14. This results in the spray discharge of the liquid being dispensed from the nozzle 11 in an positive angle θ along direction S relative to the transverse axis Y-Y of the container 14.

The magnitude of the bend in the neck 15 is: such to result in the axis of discharge D-D being positioned at a positive angle θ of 16.5° above the transverse axis Y-Y of the container 14 (which corresponds to the ground or real life horizontal when the dispenser is placed in a upright position as shown in FIGS. 1 to 3). The bent shape of the neck 15 therefore permanently positions the discharge body 10 in an upwardly pointing direction relative to the transverse axis Y-Y of the container 14. The angle θ that the neck 15 positions the discharge body 10 allows an end user to more easily and comfortably reach and direct the spray towards varying angled hard to reach surfaces such as in a toilet where the dispenser will typically be used in a variety of orientations, including inverted.

The ergonomic shape of the neck 15 is also adapted to allow a user to comfortably hold the spray dispenser. This is achieved through the tubular shape of the neck 15 being of a suitable diameter to be grasped in a user's hand. It is therefore intended that a user grip the container in a hand grip area 20 located at the upper area of the neck 15, therefore allowing a user to simultaneously hold the dispenser around the neck 15 with one hand and also use a free finger of the same hand to manipulate the trigger 12 to operate the spray pump located inside the discharge body 104 in same embodiments, the hand grip region could include recesses, inserts, embossing raised portions or the like.

Each of the reservoir 16 and neck 15 of the container are integrally connected and integrally formed, typically using a blow moulding process or other like process for forming a container of a plastics material so as to form a single liquid tight body.

The reservoir 16 of the container 14, is a rectangular shaped body used to store the cleaning and sanitising liquid to be dispensed through the discharge body 10. In order to store appropriate amounts of liquid, the reservoir 16 encloses a large volume in comparison to the other parts of the spray dispenser in order to store this liquid. The reservoir 16 comprises an oblong base 18 on which the container 14 can be rested when not in use. The side walls 30, 32, 34 and 36 comprise a rectangular shaped front wall 30 and rear wall 32 and generally rectangular shaped side walls 34 and 36.

As can be seen in the figures, the reservoir 16 has two distinct aspects. Firstly, as illustrated in FIG. 2, the shape and dimensions of the front 30 and rear 32 walls along the axis Z-Z (the width dimension of the container) provide a wide and generally flat planar surface 30 orientated perpendicular to the transverse axis Y-Y and parallel to the lateral axis Z-Z of the container 14. In comparison the shape and dimensions of the side walls 34 and 36 provide a small depth dimension along the transverse axis Y-Y (the depth dimension of the container). The direction the discharge nozzle 11 is orientated relative to the large flat surface of the front 30 and rear 32 walls is intentionally orientated in the illustrated manner for the convenience of the user when using the spray in a confined space. This flat surface area is also ideal for the positioning of large labels which allow for good brand communication.

The second functional section of the spray dispenser 8 is the invertible spray discharge body 10 used to dispense the liquid from the reservoir 16 and out of a nozzle 11 in the form of a foam onto the targeted surface. The discharge body 10 is attached on top of the neck 15 of the container 14 over the opening 17. The container 14 attaches to the discharge body 10 at a connection portion 17 located at the base of the discharge body 10 and the top of the container 14 in the proximity of the opening of the container 19. In the illustrated embodiment, the base of the discharge body 10 includes a internal tubular female threaded connection 25 (connection details including thread not illustrated). This connection 25 is adapted to be threaded into the Corresponding threaded male connection 27 located on the external surface at the top of the neck 15 of the container 14.

The basic function of the discharge body 10 is well known in the art, Briefly, in use, liquid spray is discharged from the discharge body 10 through a nozzle 11 using an internal cylinder pump (not illustrated) located within the discharge body 10. The internal cylinder pump is operated using a finger operated trigger 12. In its moat basic form, the cylinder pump typically comprises a piston and cylinder arrangement, having a biasing means, normally comprising a spring, to bias the piston to a position outside the cylinder. To operate the fluid pump, a user squeezes the trigger 12, which pushes the piston into the cylinder (the down stroke) forcing any liquid in the cylinder out of the pump at pressure and through the outlet to the connected nozzle 11 and onto a desired target surface. When the trigger 12 is released, the spring pushes the piston back out of the cylinder (the up stroke), sucking fluid into the pump through the inlet, typically connected to a feeding tube having one end located inside the reservoir 16.

However, it should be noted that, because the discharge body 10 is intended to be multidirectional, the dispenser 8 has a particular form of discharge body 10. Several types of suitable spray head for use in the spray dispenser S are known to be available in the art. It should be understood that a person skilled in the art would be capable of selecting a suitable trigger spray body from those available in the market and described in the background art.

Examples of suitable trigger spray bodies 10 include the multidirectional spray discharge bodies disclosed in U.S. Pat. Nos. 5,875,933, 5,897,032 and 6,102,255, each of which discloses a spray body with an inlet feed tube having a valve that is blocked by liquid surface tension. Therefore, in an upright state the valve when wetted by the liquid will form a force resulting from the liquid surface tension to prevent the gas from passing when the container is in the upright position and which will pass liquid when held in the inverted position. Each of the disclosures of the above referenced patent or patent applications is incorporated into the disclosure of this specification by reference.

The nozzle 11 of the spray body 10 can be configured to dispense liquid from the nozzle in any desired form, including as a spray, a foam, a stream, droplets or the like. In one particular embodiment of the invention, the nozzle 11 is configured to form foam from the liquid being expelled out of the internal liquid pump of the discharge body 10. Suitable nozzles are known in the art. The person skilled would be able to select a suitable foamer nozzle from those available in the market or described in the background art. Examples of suitable foamer nozzles include the nozzles described in European Patent Application No. 0808661, U.S. Pat. No. 4,350,298 and International Patent Application Publication No. WO 99/54052 (each of which is incorporated into this specification by reference).

In view of the foregoing, it will be appreciated that the invertible spray discharge body 10 of this embodiment provides a synergistic relationship between the container body 14 and the trigger spray body.

The ergonomically shaped trigger spray discharge body 10 allows a user to orientate the dispenser 8 in a plurality of directions. This newly found degree of freedom allows the shape and configuration of the container body 14 to be optimised to allow the spray dispenser 8 to be tailored to fit a suitable application. In the case of the present dispenser 8, the configuration has been optimised to allow the dispenser to more easily target the liquid foam dispensed from the discharge body 10 onto any angle surface when using the dispenser 8 in either an upright and/or inverted position.

Furthermore, when the dispenser S is used to dispense foam, a user does not have to apply excess liquid to ensure adequate coverage of the target surface. The formulation and device is capable of producing a foam effect in essentially any orientation.

Therefore, in use, the freedom of orientating the discharge body 10 in any direction away from the horizontal in combination with the unique position of the discharge body 10 and nozzle 11 of the trigger spray dispenser 8 relative to the transverse axis Y-Y of the container 14 can be used to more effectively dispense the active ingredient to a surface. In use, the spray dispenser 8 can be orientated in an inverted condition, i.e. the spray dispenser 8 is orientated in a user's hands with the discharge body 10 positioned below the container 14. This orientates the nozzle 11 in a generally downward direction and is predisposed to spraying in this direction. This allows the user to spray in a generally downwardly or horizontal direction depending on the orientation of the container in a user's hand.

One preferred application for the illustrated embodiment of the spray dispenser 8 is for use in cleaning under the rim of a toilet bowl. In this application, the spray dispenser 8 is oriented in a user's hands in an inverted condition. The user can then locate the discharge body 10 into the bowl with the nozzle angled towards the targeted surface. The nozzle 11 can therefore be either aimed under the toilet rim or the nozzle 11 placed under the rim, and the trigger 12 pulled to spray foam under the rim. The nature of the foam spray discharge ensures a good distribution/coating of the liquid under the rim, and the combination of shape and configuration of the container 14 and discharge body 10 provide a more convenient, easy dispenser for applying an antibacterial/disinfecting product to an inverted and non-horizontal surface.

Furthermore, the ergonomic shape of the container 14 allows the user to more easily and comfortably reach and direct the spray from the nozzle 11 towards varying angles in the narrow environment provided in a toilet, for instance under the rim, around the inside and outside curved surfaces of the bowl. This type of maneuverability is difficult to achieve using a traditionally configured trigger bottle—typically a user would have to get on their knees to enable them to aim the nozzle in the narrow environment provided by a toilet—whereas the present dispenser configuration 8 allows the user to spray in a standing position, and around the vertical surfaces of the cistern.

While the above description is primarily focused on the use of the dispenser 8 in toilet applications, it should be understood that it can be used in other applications, and particularly in cleaning and/or sanitising applications, including for dispensing oven cleaners, microwave oven cleaners, home upholstery cleaners, car upholstery cleaners, engine cleaners, wheel cleaners (such as for cars and trucks), general surface cleaners, household cleaners or shower cleaners. Dispenser 8 is also of particular value in dispensing cleaner liquids onto industrial equipment where use of pressured cleaners is undesirable or not allowed (e.g. aircraft in flight, around flammable materials), onto surfaces to which access is restricted, or onto articles with multiple, differently oriented surfaces. For example, when cleaning the interior of a shower cubicle it can be awkward to reach the lower portions of the cubicle owing to limited space.

Dispenser 8 may also be of value for dispensing fragrances, insecticides, oil products (such as for cooking), or the like.

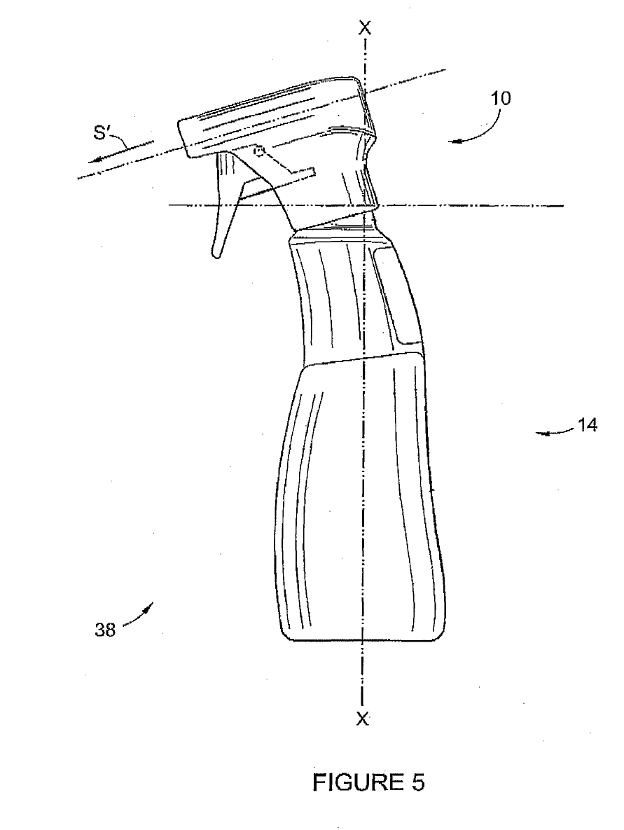

FIG. 5 is a view of a trigger spray dispenser 38 according to a second embodiment of the present invention, shown in profile. Dispenser 38 is similar in many respects to dispenser 8 of FIG. 1, so like reference numerals have been used to indicate like features. Thus, dispenser 38 includes a container 14 and a discharge body 10. The discharge body 10 is in threaded connection with container 14. The only significant-different between dispenser 38 and dispenser 8 is that discharge body 10 of dispenser 38 is directed in the opposite direction. Consequently, whereas discharge body 10 of dispenser 8 is upwardly inclined, discharge body 10 of dispenser 38 is downwardly inclined to discharge the contents of container 14 in direction S′. Thus, discharge direction S′ of dispenser 38 is below the horizontal (in the view of, FIG. 5) by approximately 16.5°.

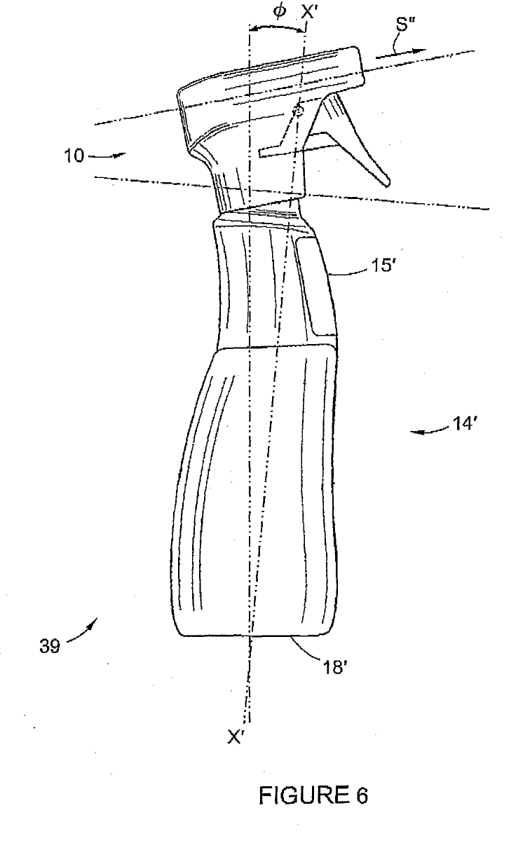

FIG. 6 is a view of a trigger spray dispenser 39 according to a third embodiment of the present invention, also shown in profile. Dispenser 39 is similar in many respects to dispenser 8 of FIG. 1, and includes a container 14, (with neck 15′) and a discharge body 10, The upwards or long axis X′-X′ of spray dispenser 39, however, is inclined to the vertical by an angle φ to improve the balance of the dispenser. As will be appreciated, the rearward inclination of neck 15 in the embodiment of FIG. 1 by 16.5° may in some cases cause dispenser a of FIG. 1 to tip rearwardly (i.e. to the left in view of FIG. 1). In this embodiment, therefore, the bane 16′ of container 14′ imparts a forward inclination of 5° to the dispenser 39, so that the upwards axis X′-X′ of dispenser 39 is inclined in a forward direction, that is, in the direction opposite to the rearward inclination of neck 15′ from the vertical. Neck 15′ still imparts a rearward inclination of 16.5° to discharge body 10 but, because the base 18′ imparts a forward inclination of no to the dispenser overall, the direction of discharge S″ of dispenser 39 is approximately 11.5° above the horizontal. Thus, although the directions of discharge, relative to the horizontal, are different in dispenser 8 of FIG. 1 and dispenser 39 of FIG. 6, the rearward inclination imparted to the discharge body or head 10 is the same in both cases. It should be understood that, even were dispenser 39 given a forward overall inclination of φ=16.5° by base 18′ so that the discharge direction were horizontal, the dispenser would still provide the same benefits in use as that of FIG. 1 (and neck 15′ would still be described as imparting a rearward inclination of 16.5° to discharge body 10). This is because the particular angle at which the base meets the sidewalls of container 14 or 14′ becomes irrelevant to the functioning of the dispenser when the dispenser is being held by a user.

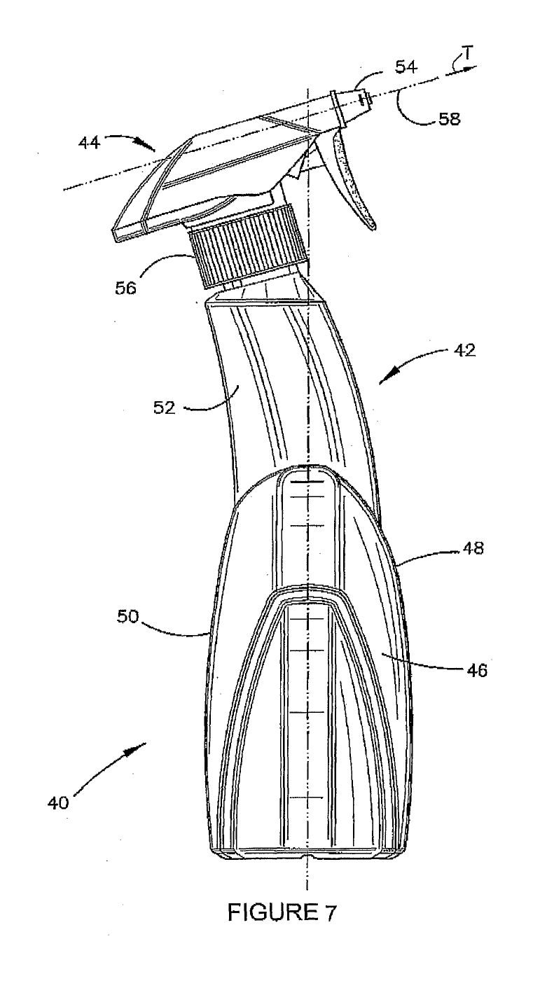

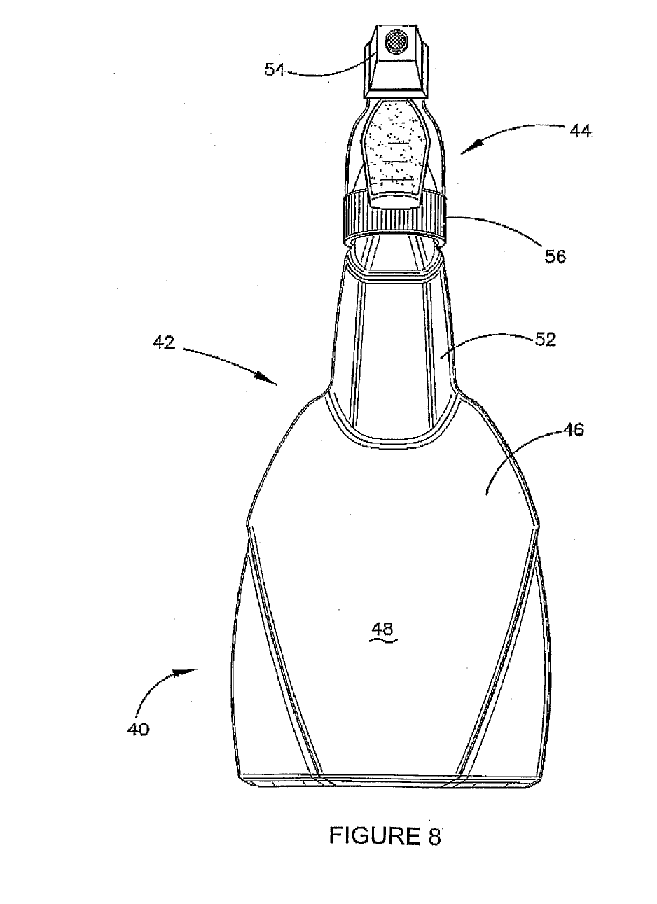

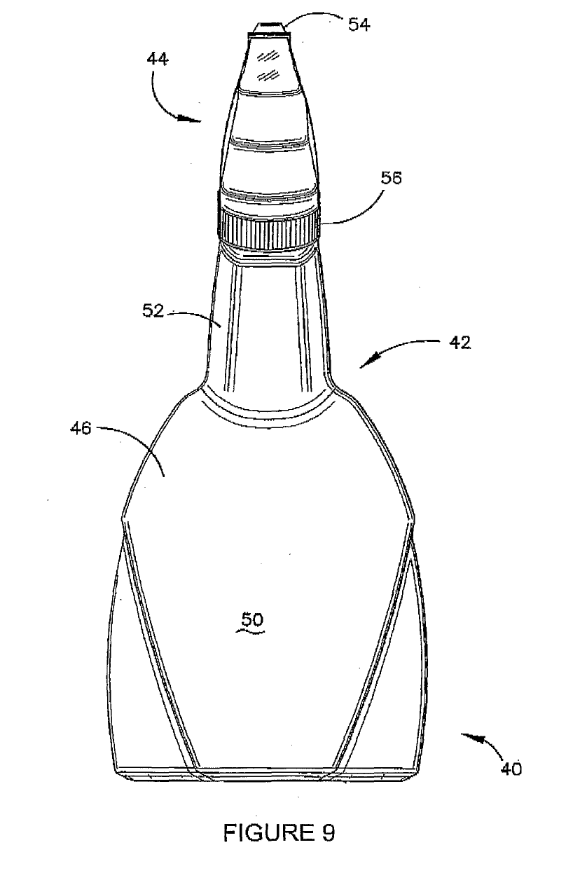

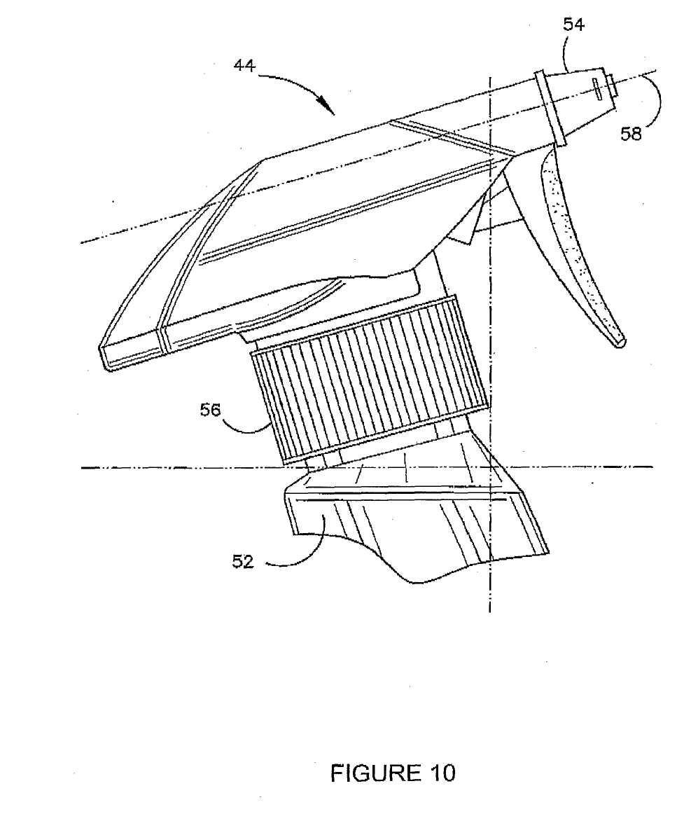

FIG. 7 is a view of a trigger spray dispenser 40 according to a fourth embodiment of the present invention, shown in profile. Dispenser 40 is similar in many respects with dispenser 8 of FIG. 1, and is adapted for comparable applications. It includes a container 42 and spray discharge head in the form of discharge body 44. FIG. 8 is a front view of dispenser 40, FIG. 9 a rear view, and FIG. 10 is a detail (shown in profile) of dispenser 40 showing the discharge body 44 and an upper portion of container 42.

Container 42 includes a reservoir 46 with forward face 48 and rear face 50. Container 42 also has a neck 52 extending upwardly from container 46. Neck 52 is generally arcuate in shape and inclined rearwardly such that its upper extremity (a threaded portion that engages discharge body 44 but is concealed by discharge body 44 in these views) is inclined rearwardly by 15°, and hence imparts a rearward inclination to discharge body 44 of 15°. Discharge body 44 is aligned such that the nozzle 54 discharges liquid in a generally forward direction.

Discharge body 44 has a nozzle 54 and an internally threaded attachment 56, rotatably located at the lower periphery of discharge body 44, for attaching discharge body 44 to the upper periphery of neck 52. Nozzle 54 is arranged to discharge liquid perpendicularly to the rotational axis of threaded portion 56. Consequently, the axis of discharge 58 of discharge body 44 and hence of dispenser 40 is inclined upwardly by an angle equal to the rearward inclination imparted by neck 52 to discharge body 44, in this embodiment 15°, to discharge the contents of the container 42 in direction T.

Thus, dispenser 40 has an axis of discharge 58 and direction of discharge T that are in a generally forward direction upwardly inclined by 15°.

Container 42 is, in this embodiment, made of high density polyethylene (HDPE) in a blow molding process. It will be appreciated, however, that other techniques (such as injection molding) and materials (such as polyethylene terephthalate (PET)) may be employed. The particular technique employed, however, may affect the chosen rearward inclination of the neck 52, as the ease with which the container may be removed from a mold may be affected by the shape of the container.

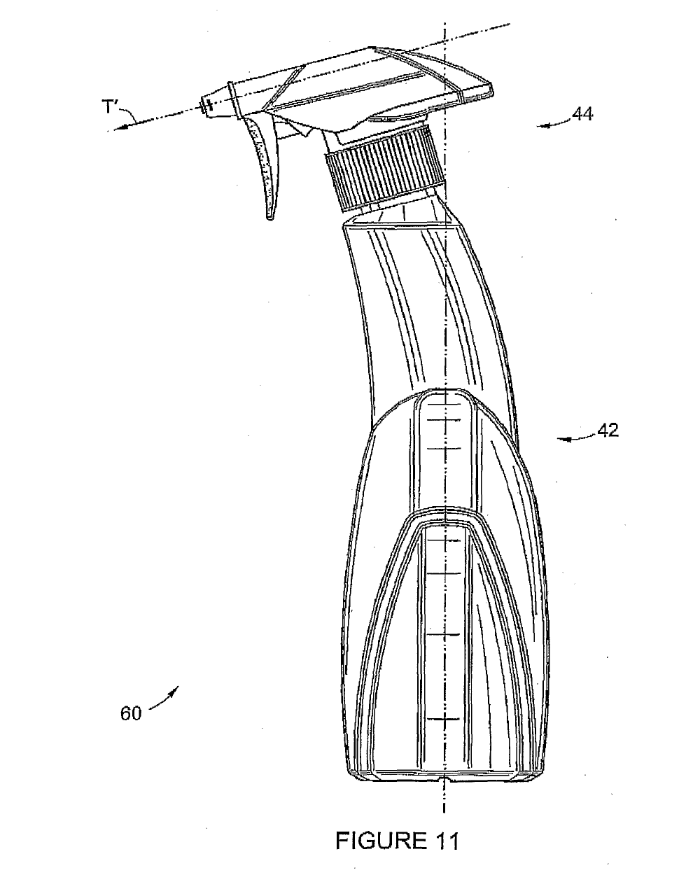

FIG. 11 is a view of a trigger spray dispenser 60 according to a second embodiment of the present invention, shown in profile Dispenser 60 is similar in many respects to dispenser 40 of FIG. 7, so like reference numerals have been used to indicate like features. Thus, dispenser 60 includes a container 42 and a discharge body 44. The discharge body 44 is in threaded connection with container 42. The only significant different between dispenser 60 and dispenser 40 is that discharge body 44 of dispenser 60 is directed in the opposite direction. Consequently, discharge body 44 of dispenser 60 is, downwardly inclined to discharge the contents of container 14 in direction T′, and discharge direction T′ of dispenser 60 is below the horizontal (in the view of FIG. 11) by approximately 15°.

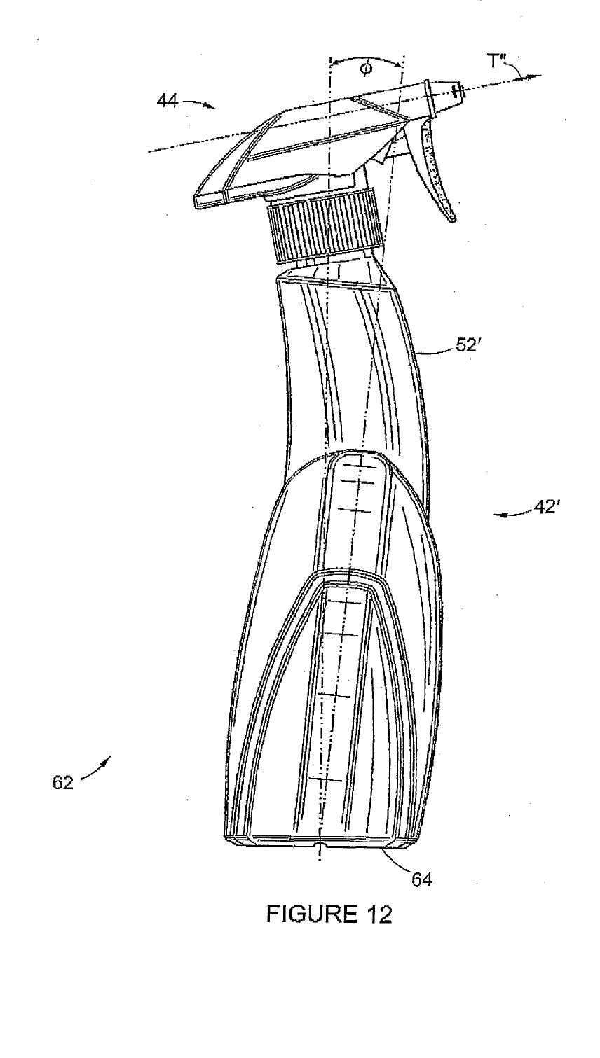

FIG. 12 is a view of a trigger spray dispenser 62 according to a third embodiment of the present invention, also shown in profile. Dispenser 62 is also similar in many respects to dispenser 40 of FIG. 7, and includes a container 42, (with neck 52′) and a discharge body 44. However, the upwards or long axis X′-X′ of spray dispenser 62—like that of dispenser 39 of FIG. 6—is inclined to the vertical by an angle φ=5° to improve the balance of the dispenser. The base 64 of container 42F imparts a forward inclination of 5° to the dispenser 60, so that the upwards axis X′-X′ of dispenser 60 is inclined in a forward direction. Neck 52′ still imparts a rearward inclination of 15′ to discharge body 44 but, because the base 64 imparts a forward inclination of 5′ to the dispenser overall, the direction of discharge T″ of dispenser 60 is approximately 10° above the horizontal. Thus, although the directions of discharge, relative to the horizontal, are different in dispenser 40 of FIG. 7 and dispenser 60 of FIG. 12, the rearward inclination imparted to the discharge body or head 44 is the sane in both cases.

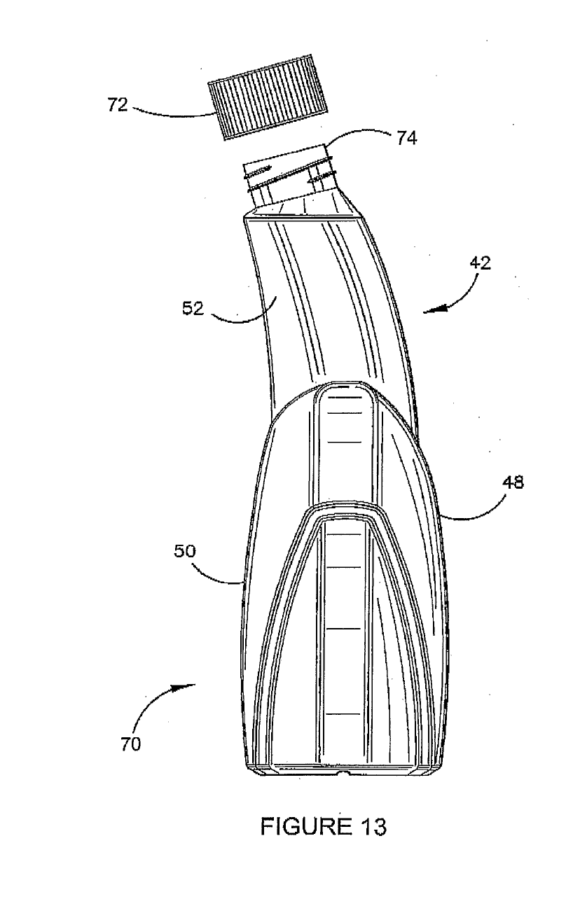

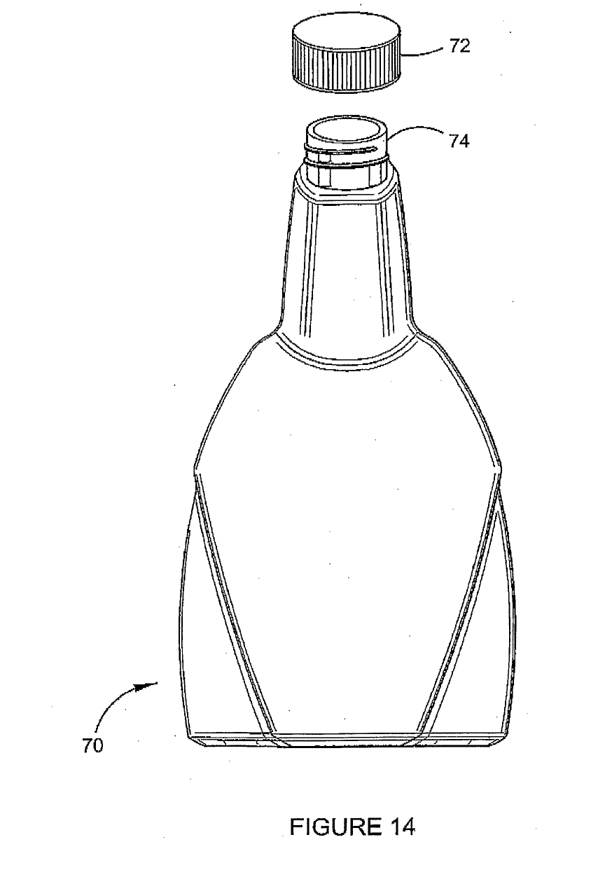

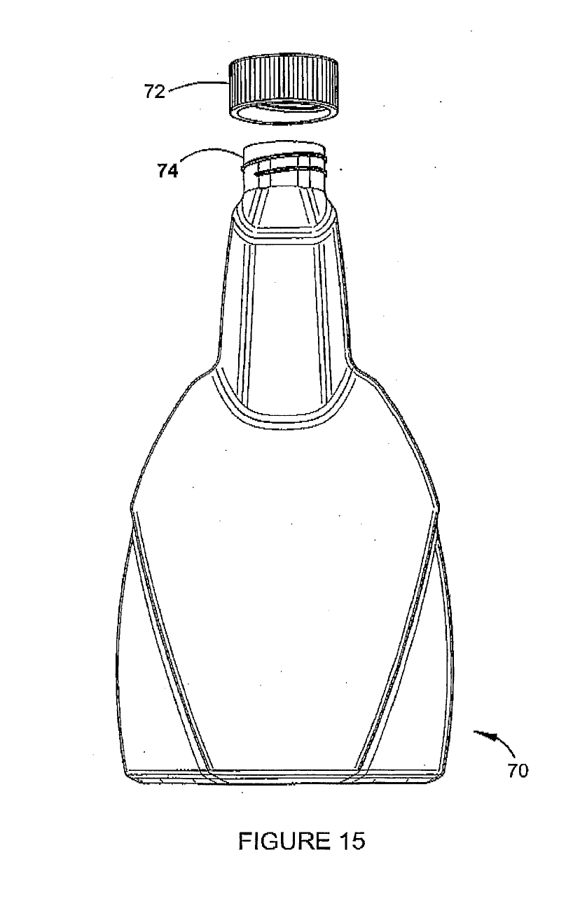

FIG. 13 is a partially exploded side view of a liquid container or “refill” 70 for use as a part of a trigger spray dispenser (such as dispenser 40 of FIG. 7) according to another embodiment of the present invention. In FIG. 13, container 70 is shown in profile. FIGS. 14 and 15 are, respectively, front and rear views of container 70.

Container 70 is essentially identical with container 46 of dispenser 40 (see FIG. 7), and like reference numerals have been used to indicate like features. However, container 70 additionally includes an internally threaded cap 72, for closing container 70. (These views are described as partially exploded only because the cap 72 is shown disengaged from the rest of container 70.)

As with container 46 of dispenser of FIG. 7, neck 52 of container 70 has a rearward inclination such that the upper portion 74 of neck 52 is rearwardly inclined by 15°. Cap 72 is complementary to upper, threaded portion 74 of neck 52, so that cap 72 can be screwed onto neck 52 to close container 70 and hence retain its contents. Container 70, filled with a liquid and closed by means of cap 72, would typically be used as a refill for a trigger spray dispenser (such as dispenser 40).

Those skilled in the art will appreciate that the invention described herein is susceptible to variations and modifications other than those specifically described. It is understood that the invention includes all such variations and modifications which fall within the spirit and scope.

It will also be understood that, although a number of background art documents are referred to herein, those references do not constitute an admission that any of these documents forms or formed a part of the common general knowledge in the art, in Australia or in any other country.

Furthermore, in the preceding description of the invention and in the following claims, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

1. A liquid container for use as a part of a trigger spray dispenser, said container comprising:
a reservoir with a base, a forward face and a rear face, said reservoir having a cross-section parallel to said base with major and minor axes, said forward and rear face being on opposite sides of said major axis; and
a neck extending upwardly from said reservoir;
wherein said neck is attachable to a spray discharge head for dispensing a liquid from said reservoir, said head being placed in fluid connection with said reservoir when attached to said neck, and at least a portion of said neck is inclined towards said minor axis to impart an inclination to said spray discharge head when so attached.

2-17. (canceled)

18. The liquid container of claim 1, wherein substantially the entire neck is inclined.

19. The liquid container of claim 1, wherein said neck comprises an attachment for attaching said head, and said attachment is inclined.

20. The liquid container of claim 1, wherein said portion of said neck is inclined by between about 10° and about 20°.

21. The liquid container of claim 1, wherein said reservoir is greater in width across said forward or rear face than in maximum distance between said forward face and said rear face.

22. A trigger spray dispenser, comprising:
a reservoir with a base, a forward face and a rear face, said reservoir having a cross-section parallel to said base with major and minor axes, said forward and rear face being on opposite sides of said major axis;
a neck extending upwardly from said reservoir; and
a spray discharge head for dispensing a liquid in a generally forward direction, wherein said neck and said spray discharge head are attached or attachable, said spray discharge head in fluid connection with liquid in the reservoir when attached to said neck, and at least a portion of said neck is inclined to impart an inclination to said spray discharge head when so attached, wherein said spray discharge head comprises an axis of discharge.

23. The trigger spray dispenser of claim 22, wherein at least a portion of said neck is rearwardly inclined so that said inclination is a rearward inclination.

24. The trigger spray dispenser of claim 22, wherein at least a portion of said neck is forwardly inclined so that said inclination is a forward inclination.

25. The trigger spray dispenser of claim 22, wherein said axis of discharge is between about 5° and about 70° from horizontal.

26. The trigger spray dispenser of claim 22, wherein said axis of discharge is between about 5° and about 70° above horizontal.

27. The trigger spray dispenser of claim 22, wherein said inclination is between about 10° and 20°.

28. The trigger spray dispenser of claim 27, wherein said inclination is about 15°.

29. The trigger spray dispenser of claim 27, wherein said inclination is about 16.5°.

30. The trigger spray dispenser of claim 22, wherein said inclination equals the angle between said axis of discharge and horizontal.

31. The trigger spray dispenser of claim 22, wherein said spray discharge head further comprises a nozzle adapted for dispensing said liquid in a form differing from the form of said liquid as stored in the reservoir.

32. The trigger spray dispenser of claim 22, wherein said liquid comprises one or more active ingredients selected from the group consisting of: an antibacterial agent, a cleaning agent, a sanitizing agent, an antimicrobial agent, a disinfectant, a detergent, a germicide, a fragrance, and an insecticide.

33. The trigger spray dispenser of claim 22, wherein said spray discharge head is adapted to selectively dispense said liquid in a plurality of directions.

34. A refill container for a trigger spray dispenser, said refill container comprising:
a reservoir with a base, a forward face and a rear face, said reservoir having a cross-section parallel to said base with major and minor axes, said forward and rear face being on opposite sides of said major axis; and
a neck extending upwardly from said reservoir, wherein said neck is attachable to a spray discharge head for dispensing a liquid from said reservoir, said spray discharge head being placed in fluid connection with said reservoir when attached to said neck, and at least a portion of said neck is inclined towards said minor axis to impart an inclination to said spray discharge head when so attached.
